(19) United States
(12) Patent Application Publication
(10) Pub. No.: US 2012/0191756 A1
(43) Pub. Date: Jul. 26, 2012

(54) TERMINAL HAVING SEARCHING FUNCTION AND METHOD FOR SEARCHING USING DATA SAVED IN CLIPBOARD

(75) Inventor: Sung Woo SON, Seoul (KR)

(73) Assignee: PANTECH CO., LTD., Seoul (KR)

(21) Appl. No.: 13/227,006

(22) Filed: Sep. 7, 2011

(30) Foreign Application Priority Data
Jan. 21, 2011 (KR) 10-2011-0006404

(51) Int. Cl. G06F 17/30

(52) U.S. Cl. 707/780; 707/E17.014

(57) ABSTRACT

A terminal to store various types of data in a clipboard allows a user to combine some or all of the various stored data for performing a search. A method includes performing a search using a combination of search keywords stored in a storing unit. The terminal includes: an input unit to receive a region selecting instruction; a storing unit to store data; and a control unit to determine a type of the selected region, to extract a search keyword corresponding to the type of the region, to store the extracted search keyword, and to perform a search using the search keyword. If more than one search keyword is stored in the storing unit, a user may select a combination of search keywords to be used for performing the search, and may set search parameters for the search keywords according to icons in the search keyword list.

### CROSS-REFERENCE TO RELATED APPLICATION

This application claims priority from and the benefit under 35 U.S.C. §119 of Korean Patent Application No. 10-2011-0006404, filed on Jan. 21, 2011, which is incorporated by reference for all purposes as if fully set forth herein.

### BACKGROUND

1. Field

The present disclosure relates to a terminal having a searching function using data saved in a clipboard and a method for searching service using data saved in a clipboard.

2. Discussion of the Background

Currently, people may obtain desired data at any place and time by using mobile terminals, such as smart phones, notebooks, and PDAs, as well as less mobile terminals, such as desktop PCs, in conjunction with available data communication services.

However, in existing terminals, the searching function may be performed by using only letters, and there is a limit in using a clipboard for various types of data other than letters. In addition, in a copy and paste method using an existing clipboard, a user copies only selected letters and pastes those copied letters in an input window when entering a searching mode. Current clipboards do not allow multiple stored entries to be combined for further use.

### SUMMARY

Exemplary embodiments of the present invention provide a terminal to store various types of data in addition to texts in a clipboard, and to allow a user to combine the various stored data for performing a search. Exemplary embodiments of the present invention also provide a method for searching based on combined data stored in the clipboard.

Additional features of the invention will be set forth in the description which follows, and in part will be apparent from the description, or may be learned by practice of the invention.

An exemplary embodiment of the present invention discloses a terminal, which includes: an input unit to receive a region selecting instruction corresponding to a selected region; a storing unit to store data; and a control unit to determine a type of the selected region, to extract a search keyword corresponding to the determined type of the selected region, to store the extracted search keyword in the storing unit, and to perform a search using the search keyword.

An exemplary embodiment of the present invention discloses a method for performing a search using a terminal, which includes: receiving a region selecting instruction corresponding to a selected region; determining a type of the selected region; extracting a search keyword corresponding to the determined type of the selected region; storing the extracted search keyword; and performing a search using the stored search keyword.

An exemplary embodiment of the present invention discloses a method for performing a search, including receiving a first region selecting instruction corresponding to a first selected region, receiving a second region selecting instruction corresponding to a second selected region, extracting a first search keyword corresponding to the first selected region, extracting a second search keyword corresponding to the second selected region, storing the first search keyword and the second search keyword, displaying a search keyword list comprising the first search keyword and the second search keyword, setting a search option comprising a search parameter for the first search keyword and the second search keyword, and performing a search using the first search keyword and the second search keyword according to the search parameter.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view showing a terminal according to an exemplary embodiment of the present disclosure.

FIG. 2 is a flowchart illustrating a method for performing a search according to an exemplary embodiment of the present disclosure.

FIG. 3 is a flowchart illustrating the process of extracting a search keyword in FIG. 2.

FIG. 4 is a flowchart illustrating the process of performing a searching mode of FIG. 2.

FIG. 5A and FIG. 5B are schematic views showing a method for selecting a searching region by a user according to an exemplary embodiment of the present disclosure.

FIG. 6 is a schematic view showing a user interface (UI) provided to a user when the user selects a searching region according to an exemplary embodiment of the present disclosure.

FIG. 7 is a schematic view illustrating a method for inputting a search form by combining search keywords stored in a clipboard according to a search option set by a user according to an exemplary embodiment of the present disclosure.

FIG. 8 is a schematic view showing a search result according to the search form of FIG. 7.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination of the enumerated elements following the respective language, including a combination of multiples of the enumerated elements or fewer than all the enumerated elements. For example, “at least one of X, Y, and Z” will be construed to mean X only, Y only, Z only, XX, YY, ZZ, or any combination of two or more items X, Y, and Z (e.g. XYZ, XZ, XXZ, YZ, or X).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

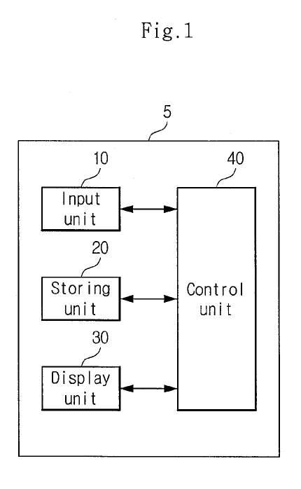

FIG. 1 is a schematic view showing a terminal according to an exemplary embodiment of the present disclosure.

Referring to FIG. 1, the terminal 5 includes an input unit 10, a storing unit 20, a display unit 30, and a control unit 40.

The terminal 5 may be a fixed terminal, such as a desktop PC, or a mobile terminal, such as a smart phone, PDA, or network-compatible tablet computer. Hereinafter, the terminal 5 will be described as a smart phone, which is a kind of mobile terminal having both voice and data communications functions.

The input unit 10 receives a searching region selecting instruction of a user. If the terminal 5 includes a touch screen, the touch screen may include both the input unit 10 and the display unit 30. A user may select a region to be searched by touching and dragging a specific region of data on the touch screen or by touching a specific region of data for a reference time. If the terminal 5 does not include a touch screen, the user may select a searching region by using the input unit 10, which may include input keys or buttons such as arrow keys.

The storing unit 20 stores data. As described in more detail below, if the control unit 40 extracts one or more search keywords according to the searching region selecting instruction, the extracted search keywords are stored in a clipboard of the storing unit 20. The clipboard may occupy the entire or a partial memory region of the storing unit 20, and the storing unit 20 may store other data to operate the terminal 5 in addition to the clipboard. The data to operate the terminal 5 may include a database that may correlated or identify search keywords according to data type, as described in more detail below.

The display unit 30 displays the operation state of the terminal 5 to a user. The display unit 30 may be a liquid crystal display (LCD) screen, an organic light emitting diode (OLED) display, or the like. The display unit 30 may be incorporated with a touch screen of the terminal 5.

The control unit 40 determines the type of search data selected by the input unit 10, extracts a search keyword corresponding to the determined type of the search data, stores the extracted search keyword in the storing unit 20, and performs searching by using the search keyword stored in the storing unit 20.

The terminal 5 allows various types of data in addition to text to be stored as search keywords in the clipboard and used for searching. It is possible to store to the clipboard multiple, separately-extracted search keywords, not just a single search keyword, so that the multiple search keywords can be combined and used for searching.

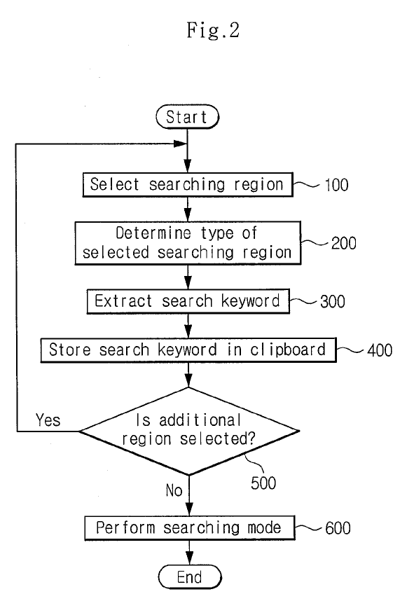

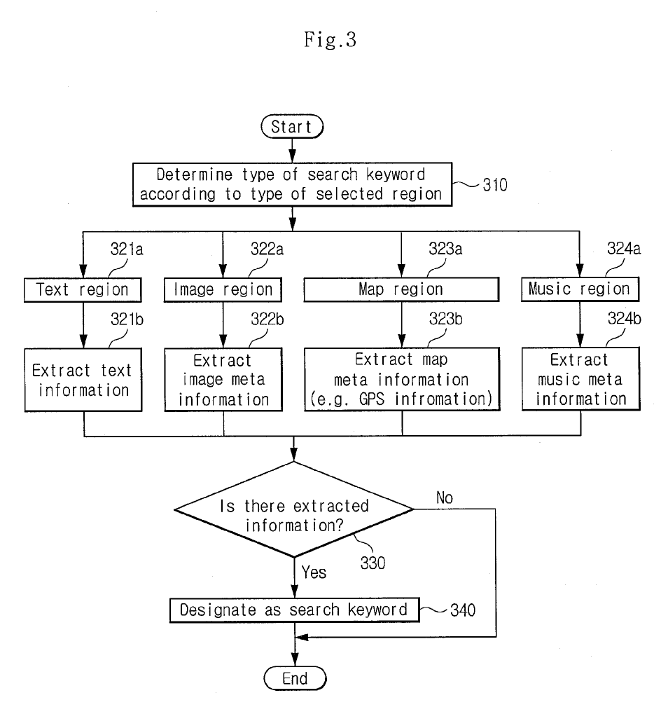

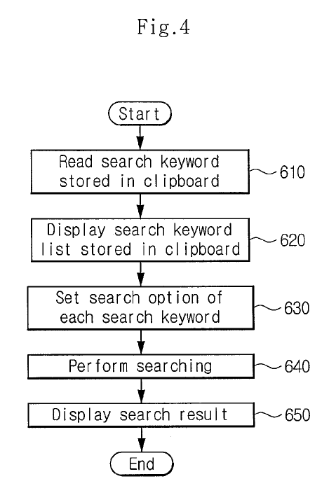

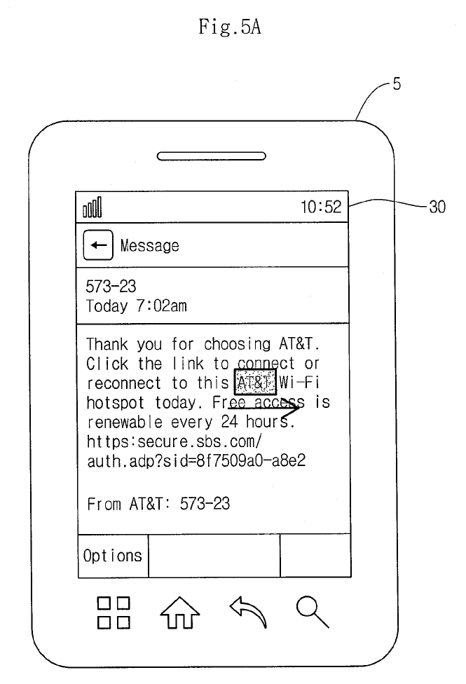

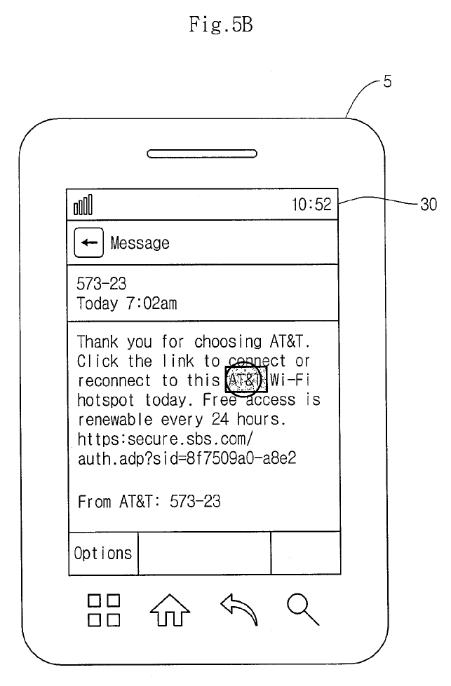

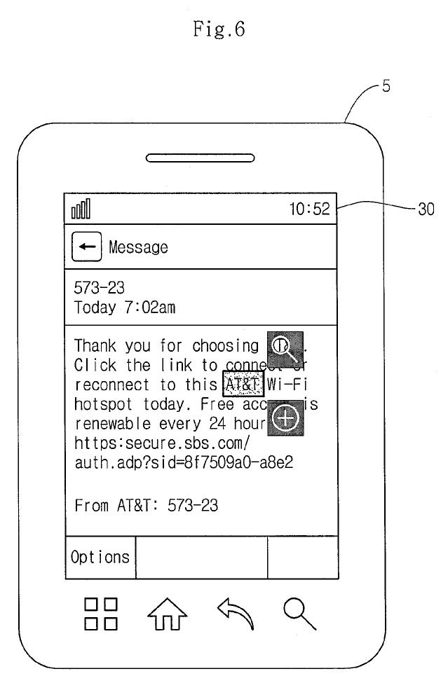

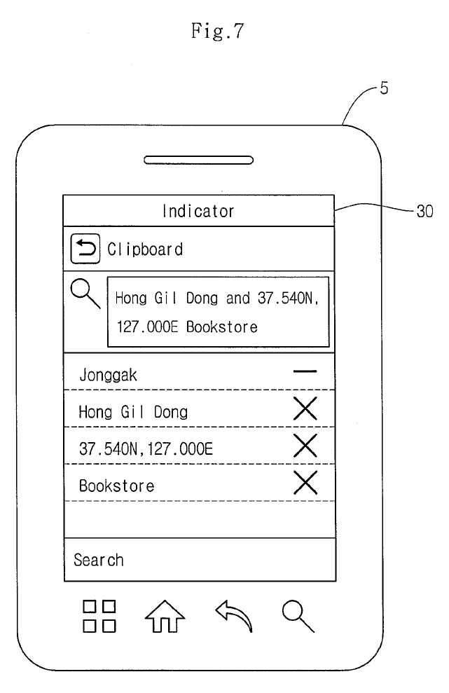

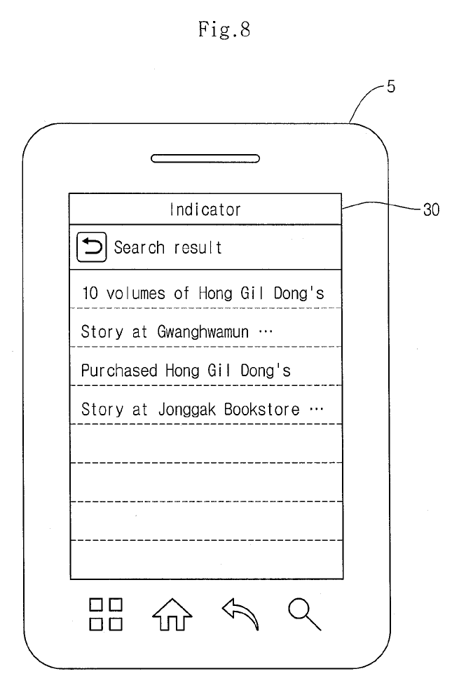

Hereinafter, a method for providing a search will be described in more detail with reference to FIG. 2, FIG. 3, FIG. 4, FIG. 5, FIG. 6, FIG. 7, and FIG. 8. The method will be described as if performed by terminal 5, but the method is not limited as such.

FIG. 2 is a flowchart illustrating a method for performing a search according to an exemplary embodiment of the present disclosure.

While using the terminal 5, the user drags the touch screen or presses the touch screen for at least a reference time to select a searching region (100). FIG. 5A and FIG. 5B are schematic views showing a method for selecting a searching region by a user according to an exemplary embodiment of the present disclosure. FIG. 5A shows that the user touches and drags the text “AT&T” in a text message displayed the display unit 30 of the terminal 5, and FIG. 5B shows that the user touches the text “AT&T” for at least a reference time to select it.

If the search data selected by the user is input to the input unit 10, the control unit 40 determines the type of the selected searching region (200). The type of the searching region selected by the control unit 40 may be determined by checking an application executing the selected searching region. In other words, the type of searching region may vary depending on the type of application executing the searching region.

If the type of the selected searching region is determined depending on the type of the application, the control unit 40 extracts a search keyword to be used for searching, from the selected searching region (300). The extracted search keyword may be text information, meta information or the like, which will be described in more detail below with reference to FIG. 3.

If the search keyword is extracted, the control unit 40 stores the extracted search keyword in the clipboard (400). As a memory region for temporarily storing the search keyword, the clipboard may occupy the entire or a partial memory region of the storing unit 20. The search keyword stored in the clipboard may be reset when the terminal 5 is rebooted.

If the search keyword is stored in the clipboard, the control unit 40 determines whether an additional searching region is selected by the user (500). For example, the terminal 5 may receive an additional searching region selecting instruction through the input unit 10 to select the selected additional searching region. If there is a selected additional searching region, the control unit 40 repeats operations 100, 200, 300, and 400 for the selected additional searching region and the additional search keyword. If there is no selected additional searching region, the search is performed in a searching mode (600).

FIG. 3 is a flowchart illustrating the process of extracting a search keyword in FIG. 2.

Referring to FIG. 3, if the type of the selected searching region is determined in Step 200, the control unit 40 determines the type of the search keyword according to the type of the selected searching region (310). The type of the search keyword according to the type of the selected searching region may be stored in the storing unit 20 as a database in advance, as explained above, or may be additionally input by the user.

The type of searching region may be a text region, an image region, a map region, a music region, and the like. If it is determined as a text region (321a), the control unit 40 extracts text information of the text region selected by the user (321b). If it is determined as an image region (322a), the control unit 40 extracts image meta information (322b). If it is determined as a map region (323a), the control unit 40 extracts map meta information, such as GPS information (323b). If it is determined as a music region (324a), the control unit 40 extracts music meta information (324b).

The control unit 40 determines whether there is extracted information after the extracting operation is performed (330), and, if there is extracted information, the control unit 40 stores the extracted information and designates the extracted information as a search keyword used for searching (340).

Describing operations 321a and 321b in more detail, the region selected by the user may be a text region if the user selects a region of a text message or selects a region of a name, a phone number, or an email address in an address book screen, for example. If the user selects a text region, the corresponding text is extracted by the control unit 40 and stored in the clipboard as a search keyword.

Describing operations 322a and 322b in more detail, the region selected by the user may be an image region if the user selects a picture or photograph while surfing the internet or executing a program or viewing a file containing the picture of photograph using the terminal 5. If the selected region is an image region, the information such as the name of the picture file, a resolution, or a compression type, which is included as meta information of the picture or photograph, may be extracted by the control unit 40 and stored in the clipboard as a search keyword.

Describing operations 323a and 323b in more detail, the region selected by the user may be a map region if the user selects a map provided by a specific portal service provider or application while surfing the internet using the terminal 5. If the user selects the map, the control unit 40 extracts meta information of the map, and the meta information may include location information such as GPS information. The extracted meta information may be stored in the clipboard as a search keyword.

Describing operations 324a and 324b in more detail, the region selected by the user may be a music region if the user selects a music file linked or regenerated while listening to music from a music file such as MP3 file or surfing the internet using the terminal 5. The meta information of the music file may be a music title, a singer, an album title or the like, and may be extracted by the control unit 40 and stored in the clipboard as a search keyword.

FIG. 4 is a flowchart illustrating the process of performing a searching mode of FIG. 2.

If a search keyword list corresponding to the region selected by the user is stored in the clipboard, a searching mode may be entered by the instruction of the user. Then, the control unit 40 reads the search keyword stored in the clipboard (610) and displays the search keyword through the display unit 30 (620). There may be only one search keyword stored in the clipboard, or there may be many search keywords. If there is more than one search keyword stored in the clipboard, the control unit 40 displays the search keyword list through the display unit 30. The search keyword list may include all search keywords stored to the clipboard in a reference period, such as in the last day, week, or reference period selected by the user, or since the last erasing of the clipboard, or may include a reduced list, such as the last five or ten stored search keywords, or example.

The control unit 40 stores the search keyword list corresponding to the selected regions respectively selected by various applications in the clipboard, and, if the searching mode is entered while a user is executing a specific application, the control unit 40 may read the search keyword list stored in the clipboard and display the search keyword list through the display unit 30. Thus, the search keyword list stored in the clipboard may be used for various applications.

If the search keyword list is displayed on the display unit 30, the user selects a search keyword from the displayed search keyword list and sets search options for the selected search keyword through a search operator (630). If there are multiple search keywords on the displayed search keyword list, the user may set search options for each selected search keyword through a search operator. As explained in more detail below with regard to FIG. 7, the search option may instruct the control unit 40 to either include the search keyword in the search, alternatively include the search keyword in the search, or to exclude the search keyword from the search.

If the user sets the search options, a search form corresponding thereto is input in an input window, and, if the user gives a search instruction, the control unit 40 performs searching according to the search form (640) and then displays a search result through the display unit 30 (650).

Hereinafter, the operations of the searching mode will be described in more detail with reference to FIG. 6, FIG. 7, and FIG. 8. As noted above, the operations will be described as if performed by terminal 5, but the operations are not limited as such.

FIG. 6 is a schematic view showing a user interface (UI) provided to a user when the user selects a searching region according to an exemplary embodiment of the present disclosure.

If the user selects a data region to be searched, a magnifying glass icon and a plus icon may be displayed vertically as shown in FIG. 6. While the magnifying glass icon and the plus icon are displayed, if the user touches the magnifying glass icon, the searching mode is entered.

While the magnifying glass icon and the plus icon are displayed, if the user touches the plus icon, the selected text “AT&T” is added to the clipboard as a search keyword. The user may add multiple search keywords to the clipboard from the same application or from various applications by using the plus icon.

FIG. 7 is a schematic view illustrating a method for inputting a search form by combining search keywords stored in a clipboard according to the search options set by a user according to an exemplary embodiment of the present disclosure.

Referring to FIG. 7, when the searching mode is entered, the search keyword list stored in the clipboard is displayed on the display unit 30 of the terminal 5. A search operator, which allows a user to select a search option, may be displayed at the side of each search keyword. There may be a default search operator for each search keyword, such as ‘−’ for every search keyword except the most recently added search keyword.

The search operator may employ ‘−’, ‘+’, ‘×’ or the like. In this case, ‘−’ represents the deletion of the corresponding search keyword, ‘+’ represents the “OR” operation, and ‘×’ represents “AND” operation. If the user selects an icon region of the search operator displayed on the display unit 30, the search operator may be changed into another search operator in a toggling manner, and the user may set a search option by clicking the icon until a desired search operator appears.

As shown in FIG. 7, “Jonggak” is deleted from the search to be performed based on search keywords, and the text information “Hong Gil Dong”, the GPS meta information “37.540N, 127.000E”, and the text information “Bookstore” are selected with the operation “AND” so that a corresponding search form is input and displayed on the input window. Though not shown in FIG. 7, it is also possible to input parentheses to set priorities of search operators.

FIG. 8 is a schematic view showing a search result according to the search form of FIG. 7.

Referring to FIG. 8, search results are shown on the display unit 30. According to the search form of FIG. 7, “Jonggak” is not included in the search, while contents related to “Hong Gil Dong” and “Bookstore” are searched at the location displayed in FIG. 7 by the GPS meta information, and the search results are as follows: “10 volumes of Hong Gil Dong's Story at Gwanghwamun . . . ” and “Purchased Hong Gil Dong's Story at Jonggak Bookstore . . . ”.

The terminal having a searching function and the method for searching according to the above-described exemplary embodiments provide a clipboard searching service that may use a combination of various data according to a user's selection.

The above-described embodiments may be implemented in whole or in part as non-transitory computer-readable codes in computer-readable recording media. The computer-readable recording media includes recording devices that store data readable by a computer system. Examples of computer-readable media include ROM, RAM, CD-ROM, magnetic tapes, floppy disks, optical disks and the like. Also, the computer-readable media may be implemented with the form of carrier wave (for example, transmission through the Internet). In addition, a computer-readable storage medium may be distributed among computer systems connected through a network and computer-readable codes or program instructions may be stored and executed in a decentralized manner. Also, functional programs, codes and code segments can be easily construed by programmers skilled in the art to which the disclosure pertains in view of the accompanying drawings.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
an input unit to receive a region selecting instruction corresponding to a selected region;
a storing unit to store data; and
a control unit to determine a type of the selected region, to extract a search keyword corresponding to the determined type of the selected region, to store the extracted search keyword in the storing unit, and to perform a search using the search keyword.

2. The terminal according to claim 1, wherein the control unit determines the type of the selected region by checking a type of an application that is executing the selected region.

3. The terminal according to claim 1, wherein the control unit stores an additional extracted search keyword in the storing unit, and performs the search using the plurality of search keywords stored in the storing unit.

4. The terminal according to claim 3, further comprising a display unit to display the plurality of search keywords stored in the storing unit to a user,
wherein the control unit combines the plurality of search keywords according to a search option selected by the user.

5. The terminal according to claim 1, wherein the selected region comprises at least one of a text region, an image region, a map region, and a music region.

6. The terminal according to claim 5, wherein the control unit extracts meta information of the selected region as a search keyword.

7. The terminal according to claim 6, wherein the meta information comprises location information if the selected region comprises the map region.

8. A method for performing a search using a terminal, comprising:
receiving a region selecting instruction corresponding to a selected region;
determining a type of the selected region;
extracting a search keyword corresponding to the determined type of the selected region;
storing the extracted search keyword; and
performing a search using the stored search keyword.

9. The method according to claim 8, wherein determining the type of the selected region comprises:
checking a type of an application that is executing the selected region.

10. The method according to claim 8, further comprising:
displaying the search keyword stored in the storing unit.

11. The method according to claim 10, further comprising:
receiving a search option set by a user,
wherein performing the search comprises:
performing the search using a single keyword selected according to the search option set by the user, or
combining a plurality of stored search keywords and performing the search using the combined search keywords.

12. The method according to claim 8, wherein the selected region comprises at least one of a text region, an image region, a map region, and a music region.

13. The method according to claim 12, wherein extracting the search keyword comprises:
extracting meta information of the selected region as a search keyword.

14. The method according to claim 13, wherein the meta information comprises location information if the selected region comprises a map region.

15. A method for performing a search, comprising:
receiving a first region selecting instruction corresponding to a first selected region;
receiving a second region selecting instruction corresponding to a second selected region;
extracting a first search keyword corresponding to the first selected region;
extracting a second search keyword corresponding to the second selected region;
storing the first search keyword and the second search keyword;
displaying a search keyword list comprising the first search keyword and the second search keyword;
setting a search option comprising a search parameter for the first search keyword and the second search keyword; and
performing a search using the first search keyword and the second search keyword according to the search parameter.

16. The method of claim 15, wherein the search parameter comprises an “AND” search operator.

17. The method of claim 15, wherein the search parameter comprises an “OR” search operator.
